(19) United States
(12) Patent Application Publication
(10) Pub. No.: US 2014/0102322 A1
(43) Pub. Date: Apr. 17, 2014

(54) SCREEN PRINTING MACHINE, AND SCREEN PRINTING METHOD

(71) Applicants: Michinori Tomomatsu, Yamanashi (JP); Yuuji Ootake, Yamanashi (JP); Toshiyuki Murakami, Yamanashi (JP); Minoru Murakami, Yamanashi (JP); Akira Maeda, Yamanashi (JP)

(72) Inventors: Michinori Tomomatsu, Yamanashi (JP); Yuuji Ootake, Yamanashi (JP); Toshiyuki Murakami, Yamanashi (JP); Minoru Murakami, Yamanashi (JP); Akira Maeda, Yamanashi (JP)

(73) Assignee: PANASONIC CORPORATION, Osaka (JP)

(21) Appl. No.: 14/119,704

(22) PCT Filed: Aug. 14, 2012
(86) PCT No.: PCT/JP2012/005155

§ 371 Date: Nov. 22, 2013

(30) Foreign Application Priority Data
Aug. 26, 2011 (JP) 2011-184412

(51) Int. Cl. B41F 15/44

(52) U.S. Cl. CPC B41F 15/44
USPC 101/123; 101/129

(57) ABSTRACT

A printing operation is repeatedly performed with respect to one substrate 2, the printing operation including the step of loading the substrate 2 (the step ST1), then contacting an upper surface of the substrate 2 with a mask 13 (the step ST4), reciprocating a squeegeeing operation to slide squeegees 33b on the mask 13 in contact with the substrate 2 to transfer a paste Pt on the mask 13 to the substrate 2 (the step ST7 and the step ST8), separating the substrate 2 from the mask 13 for a snap off (the step ST9), and while unloading the substrate 2 (the step ST11), performing mask cleaning to remove the paste Pt that is adhered to a lower surface of the mask 13 (the step ST12).

### TECHNICAL FIELD

The present invention relates to a screen printing machine and a screen printing method for sliding a squeegee on a mask to transfer a paste on the mask to a substrate.

### BACKGROUND ART

Conventionally, there is known a screen printing machine as a machine for printing a paste such as a solder paste on electrodes on a substrate. The screen printing machine includes a mask to be brought into contact with an upper surface of the substrate, a squeegee head arranged to transfer the paste on the mask to the substrate by performing a squeegeeing operation to slide a squeegee on the mask that is brought into contact with the substrate, and a snap-off mechanism arranged to separate the substrate from the mask to perform a snap off after the paste is transferred to the substrate by the squeegee head, and also includes a cleaning device arranged to perform mask cleaning to wipe away to remove the paste that gets in on a lower surface of the mask from an opening portion of the mask by the squeegeeing operation by the squeegee head.

In this screen printing machine, the squeegee head usually includes two squeegees, and a process for performing a squeegeeing operation one time in one direction with respect to one substrate with the use of one of the two squeegees, and then performing a squeegeeing operation in a direction opposite to the preceding direction with respect to following one substrate with the use of the other squeegee is repeated. In addition, there is also known a screen printing machine that performs a squeegeeing operation with respect to one substrate with the use of each of the above-described two squeegees (that is, a squeegeeing operation is performed two times with respect to one substrate) for a stable printing state (e.g., Patent document 1).

### RELATED ART DOCUMENTS

Patent Document Patent Document 1: JP-A-7-89208

### DISCLOSURE OF THE INVENTION

### Problems to be Solved by the Invention

However, there has been a problem in that when a squeegeeing operation is performed two times with respect to one substrate as in the conventional manner described above, printing operation time required for one substrate increases. Meanwhile, if the moving speed of the squeegee is increased in order to solve the problem, the amount of the paste that gets in on the lower surface of the mask in one squeegeeing operation increases, and “bleeding” and “bridging” are apt to occur close to electrodes on the substrate before reaching the number of squeegeeing operations, which is a specified number (e.g., ten times) for the timing of performing the mask cleaning by the cleaning device. For this reason, the incidence of printing failure is increased.

The present invention is made in view of the problem described above, and an object of the present invention is to provide a screen printing machine and a screen printing method that are capable of reducing occurrence of printing failure while securing a stable printing state.

### Means for Solving the Problems

A screen printing machine according to the present invention includes a mask to contact with an upper surface of a substrate, a squeegee head arranged to perform one time a first squeegeeing operation to slide one of two squeegees in one direction on the mask in contact with the upper surface of the substrate and perform one time a second squeegeeing operation to slide the other one of the two squeegees in a direction opposite to the direction in the first squeegeeing operation, the first squeegeeing operation and the second squeegeeing operation being performed in succession so as to transfer a paste on the mask to the substrate, a snap-off mechanism arranged to separate the substrate from the mask for a snap off after the paste is transferred to the substrate by the squeegee head, and a cleaning device arranged to perform mask cleaning to remove the paste that is adhered to a lower surface of the mask every time the snap off by the snap-off mechanism is performed.

A screen printing method according to the present invention is for repeatedly performing a printing operation with respect to one substrate, the printing operation including the steps of: loading the substrate; contacting an upper surface of the substrate that was loaded into contact with a mask; performing one time a first squeegeeing operation to slide one of two squeegees in one direction on the mask in contact with the substrate, and performing one time a second squeegeeing operation to slide the other one of the two squeegees in a direction opposite to the direction in the first squeegeeing operation, the first squeegeeing operation and the second squeegeeing operation being performed in succession so as to transfer a paste on the mask to the substrate; separating the substrate from the mask to perform a snap off after transferring the paste to the substrate, unloading the substrate after performing the snap off of the substrate; and performing mask cleaning to remove the paste that is adhered to a lower surface of the mask from which the substrate is snapped off.

The screen printing method according to the present invention is the screen printing method described above, and the mask cleaning is performed in parallel with the unloading of the substrate.

### Advantageous Effects of the Invention

In the present invention, a stable printing state can be secured because the squeegeeing operation is performed two times with respect to one substrate, and a printing failure does not easily occur because the mask cleaning is performed every timing of finishing a print of one substrate (i.e., before printing of a next substrate is started). At this point, the time required for the mask cleaning becomes short because the mask cleaning is performed at the timing of finishing the squeegeeing operations by less number of times than before (e.g., two times) so as to make it possible to finish the mask cleaning even during the time of unloading operation of the substrate. In addition, because the mask cleaning is performed at the timing of finishing the squeegeeing operations by less number of times than before, which increase a permissible amount of the paste getting onto the lower surface of the mask in one squeegeeing operation, allowing the movement speed of the squeegees to be increased accordingly, and thus the printing operation time required for one substrate can be reduced to improve productivity of the substrate.

### BRIEF DESCRIPTION OF THE DRAWINGS

FIG. 1 is a perspective view of a screen printing machine according to an embodiment of the present invention showing relevant parts.

FIG. 2 is a side view of the screen printing machine according to the embodiment of the present invention showing relevant parts.

FIG. 3 is a flow chart showing a procedure for carrying out a screen printing operation by the screen printing machine according to the embodiment of the present invention.

Section (a) and section (b) of FIG. 4 are explanatory views on a procedure for carrying out a screen printing operation by the screen printing machine according to the embodiment of the present invention.

Section (a) and section (b) of FIG. 5 are explanatory views on the procedure for carrying out the screen printing operation by the screen printing machine according to the embodiment of the present invention.

Section (a) and section (b) of FIG. 6 are explanatory views on the procedure for carrying out the screen printing operation by the screen printing machine according to the embodiment of the present invention.

FIG. 7 is a view showing a state in which mask cleaning is performed by a mask cleaner that the screen printing machine according to the embodiment of the present invention includes.

### MODE FOR CARRYING OUT THE INVENTION

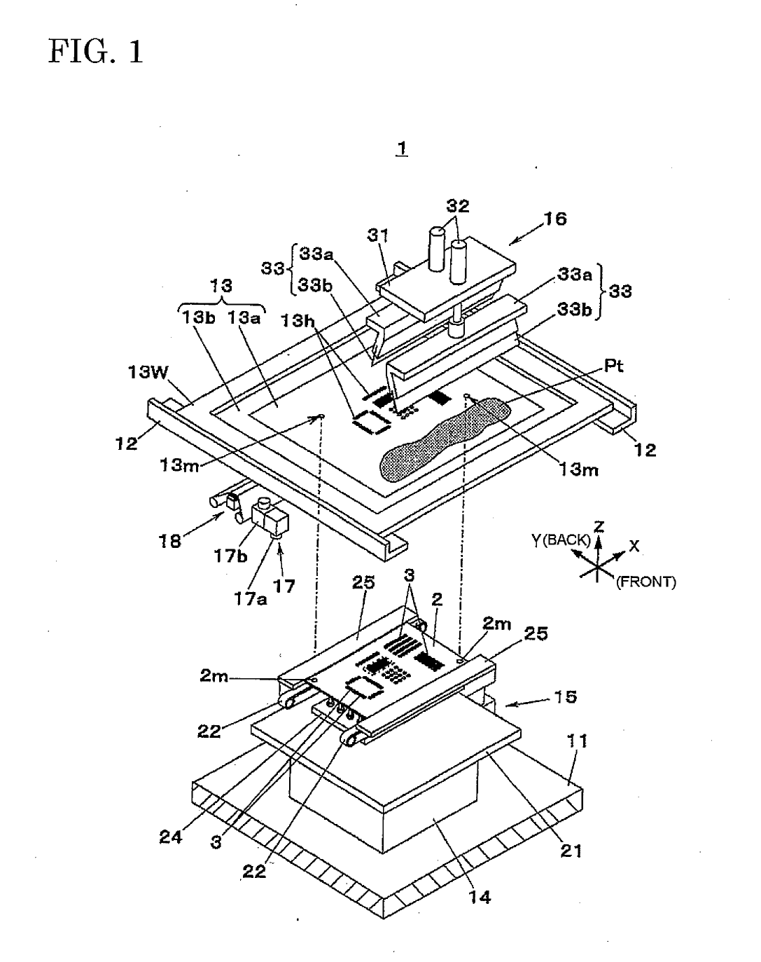

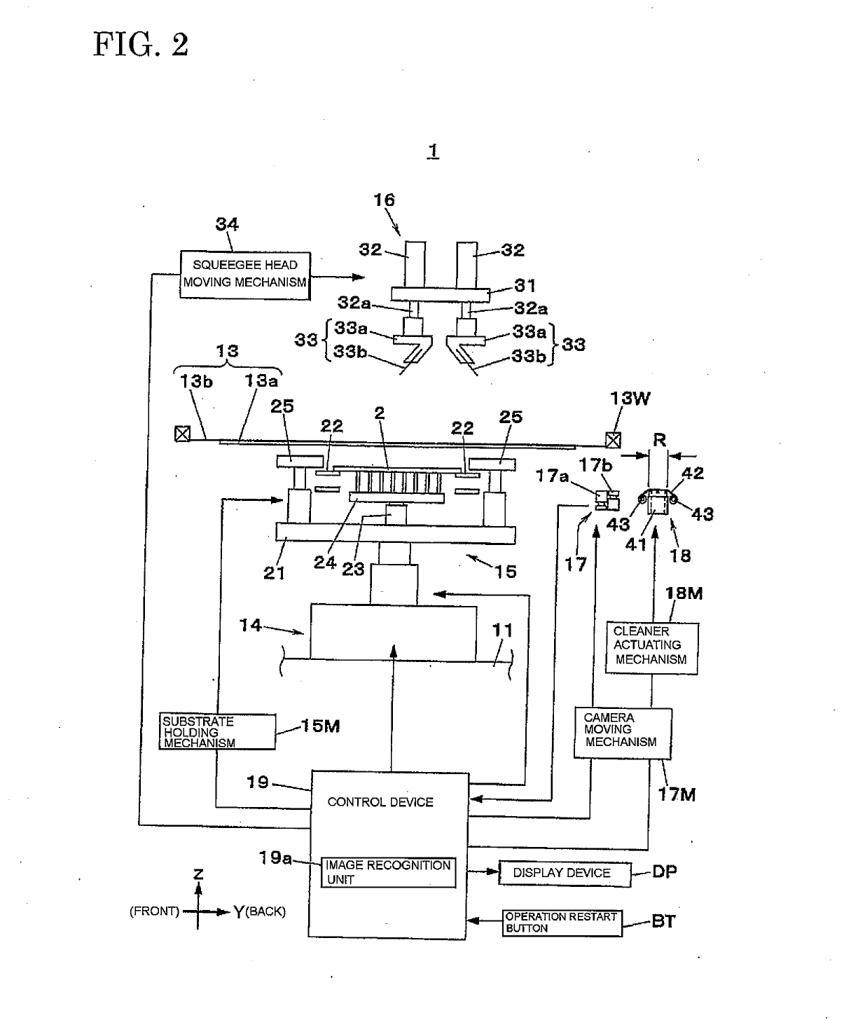

Hereinafter, a description of embodiments of the present invention will be provided with reference to drawings. In FIGS. 1 and 2, a screen printing machine 1 is arranged to perform a screen printing operation to screen-print a paste Pt such as a solder paste on number of electrodes 3 provided on a substrate 2, and includes a base 11, a pair of mask holders 12 provided above the base 11, a mask 13 that is held in a horizontal posture by the mask holders 12 and brought into contact with an upper surface of the substrate 2, a substrate holding unit moving mechanism 14 provided on the base 11, a substrate holding unit 15 that is moved by the substrate holding unit moving mechanism 14, a squeegee head 16 provided above the mask 13, a camera unit 17 that is provided in an area between the substrate holding unit 15 and the mask 13, a mask cleaner 18 arranged to perform cleaning of a lower surface of the mask 13 (mask cleaning), and a control device 19 arranged to control the operations of these members.

In FIG. 1, the mask holders 12 consist of a pair of rail-shaped members that are provided so as to be horizontal and to extend in parallel above the base 11, and the mask 13 consists of a metal plate unit 13a made of a rectangular thin metal plate that includes number of openings 13h, corresponding to the electrodes 3 on the substrate 2, and a sheet-shaped unit 13b made of a resin (e.g., polyester) that holds the four sides of the metal plate unit 13a and expands to the outside of the the metal plate unit 13a. The outer circumference (the four sides) of the sheet-shaped unit 13b is held by a mask frame 13W having a rectangular shape when seen in a plan view, and two opposing sides of the four sides of the mask frame 13W are held by the mask holders 12.

In FIG. 1, two substrate side marks 2m are provided at one diagonal position on the substrate 2, and two mask side marks 13m are provided on the metal plate unit 13a of the mask 13 so as to correspond to the two substrate side marks 2m. When the substrate 2 is brought into contact with the mask 13 in a state where the two substrate side marks 2m are made to vertically coincide with the two mask side marks 13m, the electrodes 3 on the substrate 2 are brought into a state of coinciding with the openings 13h of the mask 13.

The substrate holding unit moving mechanism 14 consists of an XYZ robot, and the substrate holding unit 15 consists of a unit base 21 of which movement (including rotation) in a direction within a horizontal plane (an XY plane) and movement in a vertical direction (a Z-axis direction) are performed by the substrate holding unit moving mechanism 14, a pair of conveyers 22 that are attached to the unit base 21 and arranged to convey the substrate 2 in one direction within the horizontal plane (an X-axis direction), a lower receiving part elevating cylinder 23 provided to the unit base 21, a lower receiving part 24 that is moved up and down by the lower receiving part elevating cylinder 23, and a pair of clamp members 25 that are provided so as to be openable and closable in a direction within the horizontal plane (a Y-axis direction) that is perpendicular to the conveyed direction of the substrate 2 (the X-axis direction) as shown in FIGS. 1 and 2.

The pair of conveyers 22 perform conveyance of the substrate 2 in the one direction within the horizontal plane (the X-axis direction), and positioning of the substrate 2 at a predetermined work position (the position shown in FIG. 1). The lower receiving part 24 raises the substrate 2 from underneath to hold the substrate 2 such that both ends of the substrate 2 that has been moved up and down by the lower receiving part elevating cylinder 23 to be positioned at the working position are separated upward from the conveyers 22, and the pair of clamp members 25 sandwich (clamp) from the Y-axis direction both lateral sides of the substrate 2 that has been raised to be held by the lower receiving part 24. Thus, the substrate holding unit 15 functions as a substrate holding member arranged to load the substrate 2 with the use of the conveyers 22 and hold the substrate 2.

The substrate holding unit moving mechanism 14 moves the substrate holding unit 15 that holds the substrate 2 to bring the substrate 2 into contact with the mask 13, and to also separate the substrate 2 from the mask 13.

In FIGS. 1 and 2, the squeegee head 16 consists of a base unit 31 having a plate shape, two squeegee elevating cylinders 32 that are attached to the base unit 31, and two squeegee units 33 that vertically move under the base unit 31 by the operations of the two squeegee elevating cylinders 32. The squeegee head 16 (the base unit 31) is moved in a reciprocating manner in the horizontal direction (the Y-axis direction) with respect to the mask 13 by a squeegee head moving mechanism 34 consisting of an actuator and the like that is not shown in the drawings.

In FIGS. 1 and 2, each of the squeegee units 33 consists of a squeegee holder 33a that is attached to a piston rod 32a of the squeegee elevating cylinder 32 and extends in the X-axis direction, and a squeegee 33b that is attached to the squeegee holder 33a and made of a thin plate member. Each of the squeegee units 33 moves up and down under the base unit 31 by projecting and sinking downward movement of the piston rod 32a of the squeegee elevating cylinder 32; however, a relative position in the vertical direction between the mask 13 and the base unit 31 does not change, so that moving down each of the squeegee units 33 with respect to the base unit 31 can bring the squeegees 33b into contact with the mask 13 from above.

An operator (not shown in the drawings) who operates the screen printing machine 1 is usually positioned at one side in a direction in which the two squeegees 33b are opposed to each other (the Y-axis direction), and in the following description, the side where the operator is positioned is referred to as the front of the screen printing machine 1, and the opposite side is referred to as the back of the screen printing machine 1.

In FIGS. 1 and 2, the camera unit 17 consists of a downward imaging camera 17a of which a field of view is oriented downward, and an upward imaging camera 17b of which a field of view is oriented upward. The camera unit 17 is moved in a direction within the horizontal plane in the area between the substrate holding unit 15 and the mask 13 by a camera moving mechanism 17M (FIG. 2) consisting of an actuator and the like that are not shown in the drawings.

The mask cleaner 18 consists of a nozzle unit 41 that is made of a tubular member having a rectangular shape in cross section when seen in a plan view and is provided so as to be movable in a direction parallel to the mask 13 (the Y-axis direction) and in the vertical direction (the Z-axis direction), and a paper member 42 that is bridged over an upper end portion of the nozzle unit 41. The portion of the paper member 42 that is bridged over the upper end portion of the nozzle unit 41 defines a wiping region R that wipes away a residue of the paste Pt that is brought into contact with the lower surface of the mask 13 and adhered thereto.

The mask cleaner 18 is movable in the direction within the horizontal plane and movable in the vertical direction, and by moving the mask cleaner 18 in the Y-axis direction while the paper member 42 is pressed against the lower surface of the mask 13 by the upper end portion of the nozzle unit 41, the paste Pt that is adhered to the lower surface of the mask 13 is wiped away. The wiping region R can be renewed by winding up the paper member 42 with the use of a pair of roller members 43.

In FIG. 2, an air suction pipe line that is not shown in the drawing is provided inside the nozzle unit 41, so that by suctioning the air into the air suction pipe line via the wiping region R of the paper member 42, the effect of wiping the paste Pt by the paper member 42 can be improved.

As for the operations of conveying the substrate 2 and positioning the substrate 2 at the working position by the conveyers 22 of the substrate holding unit 15, the lower receiving operation by the lower receiving part 24 with respect to the substrate 2 of which position is at the working position, and the clumping operation by the pair of clamp members 25, these operations are performed by the control device 19 which operates a substrate holding mechanism 15M (FIG. 2) consisted of an actuator and the like including the above-described lower receiving part elevating cylinder 23, while the operation of moving the substrate holding unit 15 in the direction within the horizontal plane and in the vertical direction, with holding the substrate 2, is performed by the control device 19 which operates the above-described substrate holding unit moving mechanism 14.

The operation of moving the squeegee head 16 (the base unit 31) in the reciprocating manner in the Y-axis direction is performed by the control device 19's controlling the operation of the above-described squeegee head moving mechanism 34, and the operation of moving up and down each of the squeegee units 33 (that is, the squeegees 33b) with respect to the base unit 31 is performed by the control device 19's controlling the operation of the two squeegee elevating cylinders 32.

The operation of moving the camera unit 17 within the horizontal plane is performed by the control device 19's controlling the operation of the above-described camera moving mechanism 17M. Each of control of an imaging operation by the downward imaging camera 17a and control of an imaging operation by the upward imaging camera 17b is performed by the control device 19, and each of image data that is obtained by the imaging operation of the downward imaging camera 17a and image data that is obtained by the imaging operation of the upward imaging camera 17b is sent to the control device 19 to be subjected to image recognition processing in an image recognition unit 19a (FIG. 2) of the control device 19.

A mechanism for moving the mask cleaner 18 within the horizontal plane is commonly used for the camera moving mechanism 17M, and the operation of moving the mask cleaner 18 in the direction within the horizontal plane is performed by the control device 19's controlling the operation of the above-described camera moving mechanism 17M. The operation of moving the mask cleaner 18 in the vertical direction, the operation of winding up the paper member 42, and the operation of suctioning the paste Pt via the paper member 42 are performed by the control device 19's controlling the operation of a cleaner actuating mechanism 18M (FIG. 2) consisting of an actuator and the like that are not shown in the drawings.

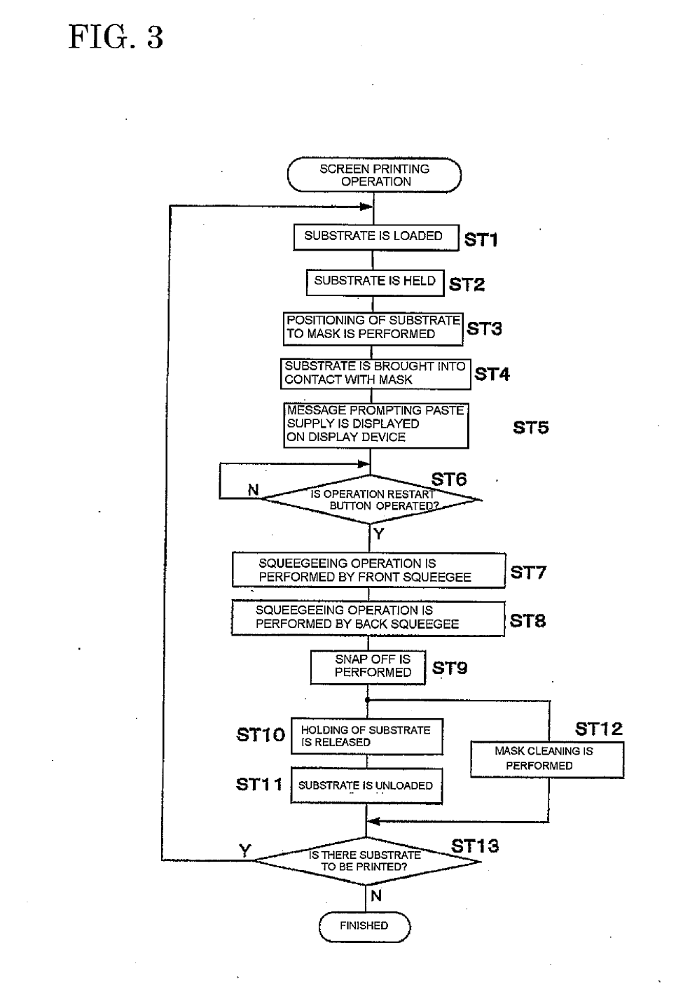

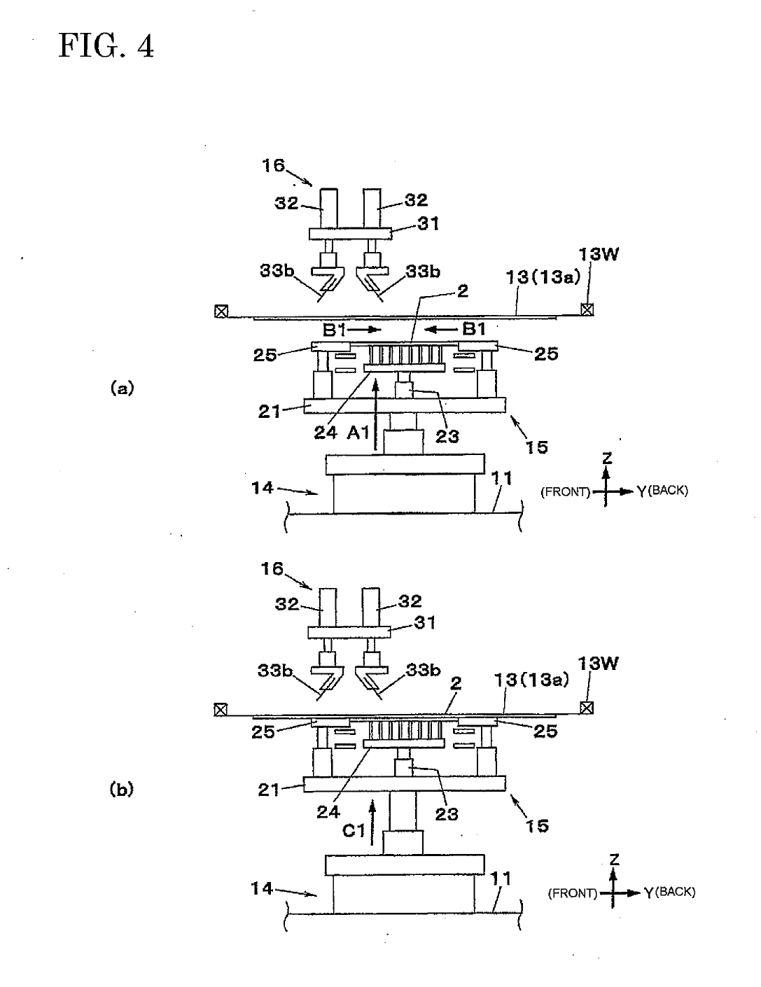

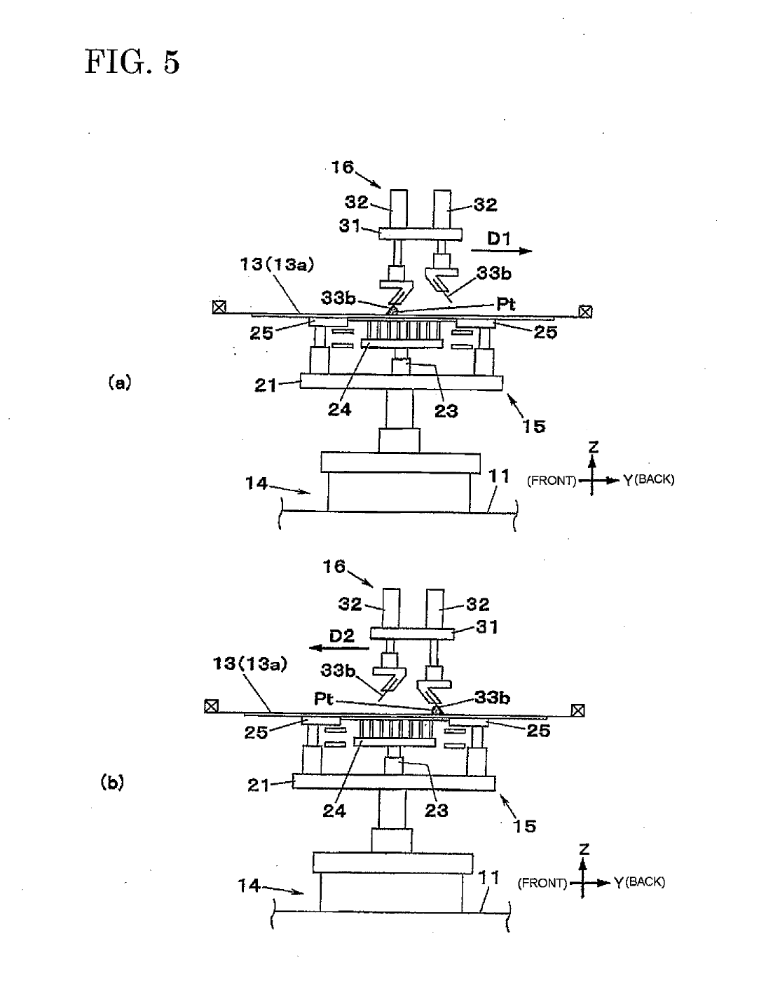

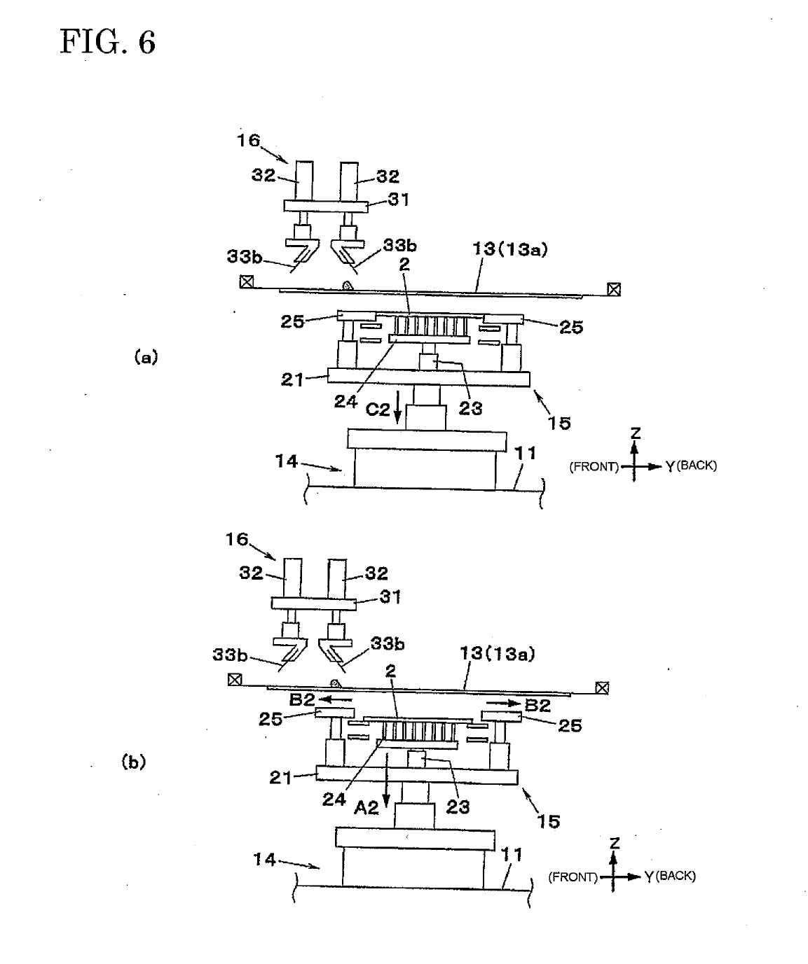

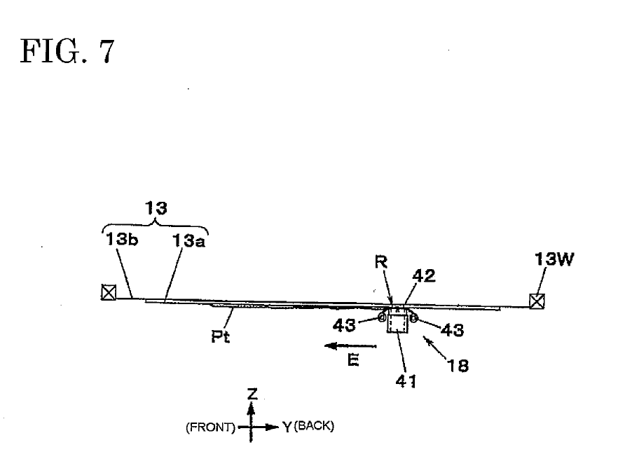

Next, referring also to the flow chart of FIG. 3 and the explanatory views of section (a) and section (b) of FIG. 4 to FIG. 7, a description of a procedure for carrying out a screen printing operation (a screen printing method) by the screen printing machine 1 will be provided. Once detection is made such that the substrate 2 has been conveyed from another device (not shown in the drawings) disposed upstream to the screen printing machine 1, the control device 19 of the screen printing machine 1 actuates the conveyers 22 of the substrate holding unit 15, loads the substrate 2 into the screen printing machine 1 (the step ST1 shown in FIG. 3), and controls the operation of the substrate holding mechanism 15M to hold the substrate 2 (Section (a) of FIG. 4. the step ST2 shown in FIG. 3).

At this point, to be specific, the substrate 2 is held by lifting the lower receiving part 24 with the use of the lower receiving part elevating cylinder 23 so as to be brought into a state of floating from the conveyers 22 (the arrow A1 shown in section (a) of FIG. 4), and by driving the pair of clamp members 25 in a closing direction to sandwich both the ends of the substrate 2 (the arrows B1 shown in section (a) of FIG. 4)

After the substrate 2 is held, the control device 19 controls the operation of the camera moving mechanism 17M to place the downward imaging camera 17a immediately over the substrate side marks 2m provided on the substrate 2, and controls the downward imaging camera 17a to capture the images of the substrate side marks 2m to grasp the position of the substrate 2 based on data on the images, while placing the upward imaging camera 17b immediately under the mask side marks 13m provided on the mask 13, and controlling the upward imaging camera 17b to capture the images of the mask side marks 13m to specify the position of the mask 13 based on data of the images. Then, the substrate holding unit 15 is moved in the direction within the horizontal plane, and the substrate side marks 2m are vertically opposed to the mask side marks 13m, and thus positioning in the direction within the horizontal plane of the substrate 2 with respect to the mask 13 is performed (the step ST3 shown in FIG. 3).

After the positioning of the substrate 2 with respect to the mask 13 is finished, the control device 19 controls the operation of the substrate holding unit moving mechanism 14 to elevate the substrate holding unit 15 with respect to the base 11 (the arrow C1 shown in section (b) of FIG. 4) to bring the upper surface of the substrate 2 (and upper surfaces of the pair of clamp members 25) into contact with a lower surface of the the metal plate unit 13a of the mask 13 from below (Section (b) of FIG. 4. the step ST4 shown in FIG. 3). Thus, the electrodes 3 on the substrate 2 are brought into a state of coinciding with the openings 13h of the mask 13.

After bringing the substrate 2 into contact with the mask 13, the control device 19 controls a display device DP (FIG. 2) connected to the control device 19 to display a message prompting the operator to supply the paste Pt (the step ST5 shown in FIG. 3). In response to this message, the operator visually confirms the currently remaining paste Pt on the mask 13, and based on the amount of the confirmed paste Pt, makes a judgment on whether or not the paste Pt should be supplied (added). Then, when a judgment that the paste Pt should be supplied is made, the paste Pt is supplied on the mask 13 from a paste supplying syringe that is prepared separately and not shown in the drawings. Then, after the supply of the paste Pt is finished, the operator operates an operation restart button BT (FIG. 2) that is connected to the control device 19. Even when the operator makes a judgment that the paste Pt is unnecessary to supply, the operator operates the operation restart button BT.

After controlling the display device DP to display the message prompting supply of the paste Pt in the step ST5, the control device 19 makes a judgment at regular time intervals on whether or not the operation restart button BT is operated (the step ST6 shown in FIG. 3), and when the control device 19 detects that the operation restart button BT is operated by the operator based on a signal output from the operation restart button BT, the control device 19 performs in succession a squeegeeing operation by the squeegee 33b that is the squeegee of the two squeegees 33b that is disposed at a front side (hereinafter, referred to as the front squeegee 33b) (the step ST7 shown in FIG. 3), and a squeegeeing operation by the squeegee 33b that is the squeegee of the two squeegees 33b that is disposed at a back side (hereinafter, referred to as the back squeegee 33b) (the step ST8 shown in FIG. 3).

At this point, in the squeegeeing operation by the front squeegee 33b, the control device 19 places the squeegee head 16 over the clamp member 25 that is in front to lower the front squeegee 33b, brings a lower end of the front squeegee 33b into contact with the upper surface of the mask 13 that is in contact with the clamp members 25, and moves the squeegee head 16 backward (Section (a) of FIG. 5. the arrow D1 shown in the drawing). Then, when the front squeegee 33b arrives over the back clamp member 25, the front squeegee 33b is raised to its original position. Meanwhile, in the squeegeeing operation by the back squeegee 33b, the control device 19 places the squeegee head 16 over the clamp member 25 that is in back to lower the back squeegee 33b, brings a lower end of the back squeegee 33b into contact with the upper surface of the mask 13 that is in contact with the clamp members 25, and moves the squeegee head 16 forward (Section (b) of FIG. 5. the arrow D2 shown in the drawing). Then, when the back squeegee 33b arrives over the front clamp member 25, the back squeegee 33b is raised to its original position.

Thus, the squeegee head 16 performs one time the first squeegeeing operation to slide one squeegee (the front squeegee 33b) of the two squeegees 33b in the one direction within the horizontal plane (backward) on the mask 13 that is in contact with the upper surface of the substrate 2, performs one time the second squeegeeing operation to slide the other squeegee (the back squeegee 33b) of the two squeegees 33b in the direction opposite to the direction in the first squeegeeing operation (forward), the first squeegeeing operation and the second squeegeeing operation being performed in succession, so as to transfer the paste Pt on the mask 13 to the substrate 2.

After the squeegeeing operation by the front squeegee 33b in the step ST7 and the squeegeeing operation by the back squeegee 33b in the step ST8 are finished, the control device 19 controls the operation of the substrate holding unit moving mechanism 14 to lower the substrate holding unit 15 (the arrow C2 shown in section (a) of FIG. 6), and performs a snap off of the substrate 2 (Section (a) of FIG. 6. the step ST9 shown in FIG. 3).

As described above, in the present embodiment, after the paste Pt is transferred to the substrate 2 by the squeegee head 16, the substrate holding unit moving mechanism 14 is functioning as a snap-off mechanism arranged to separate the substrate 2 from the mask 13 to perform a snap off.

After performing the snap off of the substrate 2, the control device 19 controls the operation of the substrate holding mechanism 15M to open the pair of clamp members 25 (the arrows B2 shown in section (b) of FIG. 6), to lower the lower receiving part 24 (the arrow A2 shown in section (b) of FIG. 6), and to put down both the ends of the substrate 2 on the pair of conveyers 22. Thus, holding of the substrate 2 by the substrate holding unit 15 is released (Section (b) of FIG. 6. the step ST10 shown in FIG. 3).

After the holding of the substrate 2 is released, the control device 19 controls the operation of the substrate holding unit moving mechanism 14 to move the substrate holding unit 15 within the horizontal plane to adjust the orientation of the conveyers 22, and controls the operation of the conveyers 22 to unload the substrate 2 to the outside of the screen printing machine 1 (the step ST11 shown in FIG. 3).

At this point, after performing the snap off in the step ST9, the control device 19 performs, in parallel with performing the operation of releasing holding of the substrate 2 in the step ST10 and the operation of unloading the substrate 2 in the step ST11, mask cleaning of the lower surface of the mask 13 by controlling the mask cleaner 18 to wipe away the residue of the paste Pt that is adhered to the lower surface of the mask 13 (the step ST12 shown in FIG. 3).

In this mask cleaning operation, the control device 19 controls the operations of the camera moving mechanism 17M and the cleaner actuating mechanism 18M to press the wiping region R of the paper member 42 of the mask cleaner 18 against the lower surface of the mask 13, and then moves the nozzle unit 41 in the direction within the horizontal plane (the Y-axis direction) (the arrow E shown in FIG. 7) to wipe away the residue of the paste Pt that is adhered to the lower surface of the mask 13 with the use of the paper member 42. At this point, when performing the mask cleaning described above, the control device 19 performs an operation of suctioning air via the air suction pipe line provided inside the nozzle unit 41. The control device 19 winds up the paper member 42 to renew the wiping region R of the paper member 42 when the paste Pt that adheres to the wiping region R of the paper member 42 increases.

As described above, in the present embodiment, the mask cleaner 18 is a cleaning device arranged to perform mask cleaning to remove the paste Pt that is adhered to the lower surface of the mask 13 at each timing of snap off being performed by the substrate holding unit moving mechanism 14 functioning as the snap-off mechanism.

After unloading the substrate 2, the control device 19 makes a judgment on whether there is another substrate 2 on which screen printing is to be performed (the step ST13 shown in FIG. 3). As a result, if there is another substrate 2 on which screen printing is to be performed, the control device 19 returns to the step ST1 to load a new substrate 2, and if there is no substarte 2 on which screen printing is to be performed, the control device 19 finishes a series of the screen printing operation.

As described above, in the screen printing machine 1 according to the present embodiment, the control device 19 is arranged to repeatedly perform the printing operation (the step ST1 to the step ST12) with respect to one substrate 2, the printing operation consisting of a series of operations such that the conveyers 22 load the substrate 2, that the substrate holding unit 15 and the substrate holding unit moving mechanism 14 then hold the loaded substrate 2 to bring the substrate 2 into contact with the mask 13, that the squeegee head 16 performs one time the first squeegeeing operation to slide the one squeegee (the front squeegee 33b) of the two squeegees 33b in the one direction on the mask 13 that is brought into contact with the substrate 2, performs one time the second squeegeeing operation to slide the other squeegee (the back squeegee 33b) of the two squeegees 33b in the direction opposite to the direction in the first squeegeeing operation, the first squeegeeing operation and the second squeegeeing operation being performed in succession so as to transfer the paste Pt on the mask 13 to the substrate 2, that the substrate holding unit 15 separates the substrate 2 from the mask 13 for the snap off, and that while the conveyers 22 unload the substrate 2, the mask cleaner 18 performs the mask cleaning to remove the paste Pt that is adhered to the lower surface of the mask 13.

Then, the screen printing method according to the present embodiment is for repeatedly performing a printing operation with respect to the one substrate 2, the printing operation including the step of loading the substrate 2 (the step ST1), the step of bringing the substrate 2 that was loaded into contact with the mask 13 (the step ST4), the step of performing one time the first squeegeeing operation to slide the one of the two squeegees 33b in the one direction on the mask 13 that is brought into contact with the substrate 2, performing one time the second squeegeeing operation to slide the other one of the two squeegees 33b in the direction opposite to the direction in the first squeegeeing operation, the first squeegeeing operation and the second squeegeeing operation being performed in succession so as to transfer the paste Pt on the mask 13 to the substrate 2 (the step ST7 and the step ST8), the step of separating the substrate 2 from the mask 13 for the snap off after transferring the paste Pt to the substrate 2 (the step ST9), the step of unloading the substrate 2 after performing the snap off of the substrate 2 (the step ST11), and the step of performing mask cleaning to remove the paste Pt that is adhered to the lower surface of the mask 13 from which the substrate 2 is snapped off (the step ST12).

As described above, in the screen printing machine 1 according to the present embodiment (the screen printing method by the screen printing machine 1), a stable printing state can be secured because the squeegeeing operation is performed two times with respect to the one substrate 2, and a printing failure does not easily occur because the mask cleaning is performed every time printing of the one substrate 2 is finished (i.e., before printing of a next substrate 2 is started).

At this point, in the present embodiment, while the mask cleaning in the step ST12 is performed in parallel with the unloading of the substrate 2 in the step ST11, the time required for the mask cleaning is short because the mask cleaning is performed when the squeegeeing operations of less number of times than before (two times) are finished, and it is possible to finish the mask cleaning during the implementation of unloading operation of the substrate 2.

In addition, because the mask cleaning is performed when the squeegeeing operations of less number of times than before are finished, a permissible amount of the paste Pt that gets in on the lower surface of the mask 13 in one squeegeeing operation is increased to allow the movement speed of the squeegees 33b to be increased accordingly, so that printing operation time required for the one substrate 2 can be reduced to improve productivity of the substrate 2.

The present application is based on the Japanese Patent Application filed on Aug. 26, 2011 (No. 2011-184412), and the contents thereof are incorporated herein by reference.

Industrial Applicability

The screen printing machine and the screen printing method that are capable of reducing occurrence of printing failure while securing a stable printing state are provided.

Description of Reference Numerals and Signs
1 Screen printing machine
2 Substrate
13 Mask
14 Substrate holding unit moving mechanism (Snap-off mechanism)
16 Squeegee head
18 Mask cleaner (Cleaning device)
33b Squeegees
Pt Paste

1-3. (canceled)

4. A screen printing machine comprising:
a mask to contact with an upper surface of a substrate;
a squeegee head arranged to perform one time a first squeegeeing operation to slide one of two squeegees in one direction on the mask in contact with the upper surface of the substrate and perform one time a second squeegeeing operation to slide the other one of the two squeegees in a direction opposite to the direction in the first squeegeeing operation, the first squeegeeing operation and the second squeegeeing operation being performed in succession so as to transfer a paste on the mask to the substrate;
a snap-off mechanism arranged to separate the substrate from the mask for a snap off after the paste is transferred to the substrate by the squeegee head; and
a cleaning device arranged to perform mask cleaning to remove the paste that is adhered to a lower surface of the mask every time the snap off by the snap-off mechanism is performed.

5. A screen printing method for repeatedly performing a printing operation with respect to one substrate, the printing operation comprising:
loading the substrate;
contacting an upper surface of the substrate that was loaded into contact with a mask;
performing one time a first squeegeeing operation to slide one of two squeegees in one direction on the mask in contact with the substrate and performing one time a second squeegeeing operation to slide the other one of the two squeegees in a direction opposite to the direction in the first squeegeeing operation, the first squeegeeing operation and the second squeegeeing operation being performed in succession so as to transfer a paste on the mask to the substrate;
separating the substrate from the mask to perform a snap off after transferring the paste to the substrate;
unloading the substrate after performing the snap off of the substrate; and
performing mask cleaning to remove the paste that is adhered to a lower surface of the mask from which the substrate is snapped off.

6. The screen printing method according to claim 5, wherein the mask cleaning is performed in parallel with the unloading of the substrate.
